(19) United States
(12) Patent Application Publication
(10) Pub. No.: US 2025/0378638 A1
(43) Pub. Date: Dec. 11, 2025

(54) OCCLUSION CULLING METHOD, ELECTRONIC DEVICE AND STORAGE MEDIUM

(71) Applicant: Beijing Zitiao Network Technology Co., Ltd., Beijing (CN)

(72) Inventor: Mingxuan LI, Beijing (CN)

(21) Appl. No.: 19/235,139

(22) Filed: Jun. 11, 2025

(30) Foreign Application Priority Data
Jun. 11, 2024 (CN) 202410745463.4

(51) Int. Cl. G06T 17/00; G06T 5/80

(52) U.S. Cl. CPC G06T 17/00; G06T 5/80

(57) ABSTRACT

The present disclosure provides an occlusion culling method, an electronic device and a storage medium. The occlusion culling method is used to a compositor of an extended reality device and includes: determining a coverage range of a layer in the extended reality device, in which, the extended reality has at least two to-be-drawn layers; and in response to a target layer within a coverage range of any previous layer, skipping drawing the target layer in the compositor; the target layer is a layer except the layer closest to a human eye position in at least two layers, and the previous layer is a layer closer to the human eye position than the target layer.

### CROSS-REFERENCE TO RELATED APPLICATION

This application claims the priority to and benefits of the Chinese Patent Application, No. 202410745463.4, which was filed on Jun. 11, 2024. The aforementioned patent application is hereby incorporated by reference in its entirety.

### TECHNICAL FIELD

The present disclosure relates to an occlusion culling method, an apparatus, an electronic device and a storage medium.

### BACKGROUND

In graphics, occlusion culling is often used for reducing the amount of drawing and increasing the drawing speed, that is, one layer may occlude another layer, and the occluded part of the another layer does not need to be painted. In some techniques, occlusion culling is performed in an engine, but occlusion culling performed in the engine cannot be applied to a compositor of an extended reality device (XR compositor).

### SUMMARY

Embodiments of the present disclosure provide an occlusion culling method, an apparatus, an electronic device and a storage medium.

The present disclosure adopts the following technical solutions.

In some embodiments, the present disclosure provides an occlusion culling method, the method is used to a compositor of an extended reality device, and the method includes:
determining a coverage range of a layer in the extended reality device, wherein the extended reality device has at least two layers to be drawn; and
in response to a target layer being within a coverage range of a previous layer, skipping drawing the target layer in the compositor,
the target layer is a layer except a layer closest to a human eye position in the at least two layers to be drawn, and the previous layer is a layer closer to the human eye position than the target layer.

In some embodiments, the present disclosure provides an occlusion culling apparatus, applied to a compositor of an extended reality device, and the apparatus includes:
a computation unit, configured to determine a coverage range of a layer in the extended reality device, wherein the extended reality device has at least two layers to be drawn;
a control unit, configured to, in response to a target layer being within the coverage range of a previous layer, skip drawing the target layer in the compositor,
the target layer is a layer except a layer closest to a human eye position in the at least two layers to be drawn, and the previous layer is a layer closer to the human eye position than the target layer.

In some embodiments, the present disclosure provides an electronic device, and the electronic device includes: at least one memory and at least one processor;
the at least one memory is configured to store program codes; and the at least one processor is configured to call the program codes stored in the at least one memory to execute the occlusion culling method according to embodiments of the present disclosure.

In some embodiments, the present disclosure provides a computer-readable storage medium, the computer-readable storage medium is used to store program codes, the program codes are executed in a computer to cause the computer to execute the occlusion culling method according to embodiments of the present disclosure.

The occlusion culling method provided by embodiments of the present disclosure is used to a compositor of an extended reality device, the method includes: determining a coverage range of a layer in the extended reality device, wherein the extended reality device has at least two layers to be drawn; and in response to a target layer being within a coverage range of a previous layer, skipping drawing the target layer in the compositor, the target layer is a layer except a layer closest to a human eye position in the at least two layers to be drawn, and the previous layer is a layer closer to the human eye position than the target layer. Embodiments of the present disclosure is used to a compositor of an extended reality device.

### BRIEF DESCRIPTION OF DRAWINGS

In conjunction with the accompanying drawings and with reference to the following specific embodiments, the above and other features, advantages and aspects of each embodiment of the present disclosure will become more apparent. Throughout the accompanying drawings, identical or similar drawing marks indicate the same or similar elements. It is to be understood that the accompanying drawings are schematic and that components and elements are not necessarily drawn to scale.

FIG. 1 is a flowchart of an occlusion culling method according to an embodiment of the present disclosure.

FIG. 2 is a schematic diagram of a light ray according to an embodiment of the present disclosure.

FIG. 3 is a schematic diagram of a screen and a layer according to an embodiment of the present disclosure.

FIG. 4 is a schematic diagram of a cylinder and a curved side according to an embodiment of the present disclosure. FIG. 5 is a top view of a curved side according to an embodiment of the present embodiment.

FIG. 6 is a schematic diagram of a largest inscribed rectangle according to an embodiment of the present embodiment.

FIG. 7 is a structural schematic diagram of an electronic device according to an embodiment of the present embodiment.

### DETAILED DESCRIPTION

Embodiments of the present disclosure are described in more detail below with reference to the accompanying drawings. Although some embodiments of the present disclosure are shown in the drawings, it is to be understood that the present disclosure can be realized in various forms and should not be construed as confined to the embodiments set forth herein, but rather provided for a more thorough and complete understanding of the disclosure. It is to be understood that the drawings and embodiments of the present disclosure are for illustrative purposes only and are not intended to limit the scope of protection of the present disclosure.

It is to be understood that the steps described in implementation modes of a method of the present disclosure may be carried out in accordance with and/or in parallel. In addition, the implementation modes of thee method may include additional steps and/or omit the steps shown in the execution. The scope of the present disclosure is not limited in this regard.

The term “include” and its variations used herein are open to including, i.e., “including but not limited to”. The term “based on” is “at least partially based on”. The term “one embodiment” means “at least one embodiment”; the term “another embodiment” means “at least one additional embodiment”; The term “some embodiments” means “at least some embodiments”. The relevant definitions of other terms are given in the following descriptions.

It is to be noted that the concepts “first”, “second”, etc., mentioned in the present disclosure are only used for distinguishing different apparatuses, modules or units, and are not used to define the order or interdependence of the functions performed by these apparatuses, modules or units.

It is be noted that the modification of “one” referred to in the present disclosure is indicative and not restrictive, and those skilled in the art should understand that it is to be understood as “one or more” unless the context expressly indicates otherwise.

The names of messages or information exchanged among a plurality of apparatuses in the embodiments of present disclosure are for illustrative purposes only and are not intended to limit the scope of such messages or information.

The solution provided in the embodiments of the present application will be described in detail below in conjunction with the accompanying drawings.

In graphics, occlusion culling is often used for reducing the drawing of occluded layers, thereby reducing the drawing of layers and improving the response speed. In related techniques, culling is carried out in an engine according to the position of the vertexes of a model, however, in a compositor of an extended reality device, all layers use the same vertexes regardless of the distance because the vertexes in the compositor represent distortion rather than physical positions. The positions of the vertexes in the compositor can only be obtained when a vertex shader finishes execution and reprojection is performed in a fragment shader, but it is too late. In other related techniques, pixel-level occlusion relationship determination is performed in the fragment shader to prevent image anomalies, but this determination may lead to performance degradation and will not reduce repeated drawing; and GPU hardware cannot optimize the occlusion culling in the fragment shader, but increases the amount of computation. There are EARLY-Z, LRZ and other culling solutions for GPU hardware, but none of them are suitable for the compositor of the extended reality device. In some embodiments proposed in the present disclosure, the computation is performed once in the CPU, and no computation is performed in the GPU, so the amount of computation increased is small.

There are two main types of occlusion culling in the related techniques, one type is unity-like occlusion culling, which occurs before a drawing task starts; each object has an engine to generate an own bounding box, namely a cuboid, and the object is in the bounding box no matter how many vertexes the object has, and how complex the object is. If a cuboid is completely behind another cuboid, the rendering and drawing tasks for the object in the cuboid will be completely discarded. This mode cannot be applied in a solution of the present disclosure because the layers are 2D and superposed to each other, and such occlusion culling directly discards the rendering task, and there is no engine to generate this cuboid in the present disclosure. The other type is GPU hardware culling in the drawing task, namely rendering is started, the occlusion culling is performed in the vertex shader, and after a primitive is generated according to the vertexes, a triangle primitive will be generated by every three vertexes. If a primitive is completely occluded by another primitive, it will be culled, but in an XR compositor (compositor of an extended reality device), the vertexes represent not the actual positions but the light ray directions; the vertexes are full-screen, and represent distortion values for various positions on the screen, which are associated with XR lenses, i.e., an XR device of which the vertexes are fixed and only associated with the device lenses regardless of the drawing layer distance and size; and the XR compositor performs reprojection in the fragment shader according to the light rays, so as to compute the color of point samples. During normally drawing a layer in the middle of the screen, surrounding vertexes of the layer will be generated. The vertexes of the XR composition are always fixed, and only in fragment coloring and reprojection, a blank area outside the layer is generated due to discarding because it cannot be reprojected. According to the solution of some embodiments of the present disclosure, before rendering, the directions of light rays projected onto the upper left and lower right vertexes of this layer are computed and then are associated with the distortion value of the vertexes, and the unsatisfactory vertexes are actively deleted in the vertex shader.

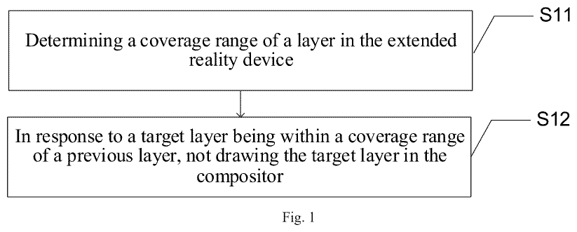

As shown in FIG. 1, FIG. 1 is a flowchart of an occlusion culling method according to an embodiment of the present disclosure, and the occlusion culling method is applied to a compositor of an extended reality device, and specifically, before rendering, the method includes the following steps:

S11: determining a coverage range of a layer in the extended reality device.

In some embodiments, the extended reality device is provided with at least two layers to be drawn.

S12: in response to a target layer within a coverage range of a previous layer, not drawing the target layer in the compositor.

In some embodiment, the target layer is a layer except a layer closest to a human eye position in the at least two layers to be drawn, and the previous layer is a layer closer to the human eye position than the target layer. The human eye position is the position of human eyes of a user using the extended reality device in an extended reality world. In the extended reality device (such as a virtual reality device, an augmented reality device and a mixed reality device), different layers are drawn on a screen by the compositor according to the distance from the human eye position of the user, and the layers are used for displaying images. The layer close to the human eyes may occlude the layer far away from the human eyes, and the drawing continuously performed on occluded invisible images may cause repeated drawing, resulting in power consumption. In some embodiments, there are at least two layers with different positions, the coverage range of each layer is computed through a CPU in the compositor (the layer farthest away from the human eye position does not occlude other layers, so it may not needed to compute the coverage range of this layer), and the target layer may be any layer except the layer closest to the human eye position. In response to that the coverage area of any previous layer between the target layer and the human eye position is covered with the target layer, the target layer does not need to be drawn, and thus power consumption is reduced.

In some embodiments of the present disclosure, for the problem that existing occlusion culling is not suitable for the compositor of the extended reality device, an occlusion culling method suitable for the compositor of the extended reality device is proposed and the method is executed before rendering, so that the drawing of an occluded layer can be reduced, the display efficiency can be improved, and the power consumption can be reduced.

In some embodiments of the present disclosure, determining a coverage range of the layer in the extended reality device, includes: determining a pitch angle range and a horizontal angle range of the layer relative to the human eye position in a local coordinate system of the layer; in response to that a pitch angle range and a horizontal angle range of the target layer are respectively within a pitch angle range and a horizontal angle range of the previous layer, the target layer is within the coverage range of the previous layer.

In some embodiments, in response to the computing of the coverage range of any layer, it is needed to perform computation in the local coordinate system of the layer to be computed. In an extended reality space displayed by the extended reality device, in response to that the pitch angle range and the horizontal angle range are determined in a screen coordinate system or a world coordinate system, the shape of the layer may have certain deformation along with the change of the human eye position of the user, so the computation of the pitch angle range and the horizontal angle range is actually inaccurate, and the pitch angle range and the horizontal angle range need to be determined in the local coordinate system (usually also called a Local coordinate system) of the layer in the embodiment. The local coordinate systems of different layers are different; in response to the computing of the pitch angle range and the horizontal angle range of a layer, the local coordinate system of this layer will be used, and the local coordinate systems of other layers are not used. For any layer, in the local coordinate system of the layer, the maximum angle ranges for simulating the human eyes to rotate to observe the layer in the vertical direction and the horizontal direction at the human eye position are the pitch angle range and the horizontal angle range of the layer,. It is to be noted that the vertical direction and the horizontal direction in the embodiment are both based on the local coordinate system of the layer in the extended reality world, and may be different from the vertical direction and the horizontal direction in the reality world; the vertical direction and the horizontal direction in the embodiment are usually directions parallel to two different coordinate axes of the local coordinate system respectively, for example, the vertical direction is usually a direction parallel to an y axis in the local coordinate system, and the horizontal direction is a direction parallel to an x axis. Therefore, the pitch angle range generally depends on a projection angle of an included angle formed by connecting lines of the highest point and the lowest point of the layer in the vertical direction and the human eye position in the vertical direction, and the horizontal angle range generally depends on a projection angle of an included angle formed by the connecting lines of the leftmost point and the rightmost point of the layer in the horizontal direction and the human eye position in the horizontal direction. According to the embodiment, the coverage range of the layer is determined through the pitch angle range and the horizontal angle range, rather than computing the range covered by the overall coverage range of the layer, so that the computation amount is reduced, and the computation speed is improved.

In some embodiments of the present disclosure, the determining a pitch angle range and a horizontal angle range of the layer relative to the human eye position in a local coordinate system of the layer includes: acquiring coordinates of at least two vertexes of the layer and a coordinate of the human eye position in the local coordinate system of the layer; and determining the pitch angle range and the horizontal angle range of the layer according to the coordinates of the at least two vertexes of the layer and the coordinate of the human eye position in the local coordinate system of the layer.

In some embodiments, the at least two vertexes are points with the maximum values or minimum values of the layer in the vertical direction or the horizontal direction; the pitch angle range and the horizontal angle range of the layer are only related to the relative position relationship between some key vertexes and the human eye position and are irrelevant to non-vertexes on the boundary, so the pitch angle range and the horizontal angle range of the layer are determined by acquiring the coordinates of the vertexes on the boundary of the layer and the coordinates of the human eye position. Therefore, all points in the layer are prevented from being computed. In order to compute the pitch angle range and the horizontal angle range, at least two vertexes are needed.

In some embodiments of the present disclosure, the determining the pitch angle range and the horizontal angle range of the layer according to the coordinates of the at least two vertexes of the layer and the coordinate of the human eye position in the local coordinate system of the layer includes: computing a tangent value of a pitch angle and a tangent value of a horizontal angle corresponding to a connecting line from the human eye position to each vertex; and obtaining a tangent value range corresponding to the pitch angle range and a tangent value range corresponding to the horizontal angle range according to the tangent value of the pitch angle and the tangent value of the horizontal angle corresponding to each connecting line, the tangent value range corresponding to the pitch angle range and the tangent value range corresponding to the horizontal angle range represent the pitch angle range and the horizontal angle range.

In some embodiments, the connecting lines from the human eyes to the vertexes describe the boundary of the layer; the coordinates of the connecting lines in the local coordinate system of the layer are represented as (X, Y, Z); it is assumed that the y axis refers to a numerical direction, the x axis refers to a horizontal direction, an z axis is vertical to the direction of the layer, and the layer is parallel to a plane with the x axis and the y axis, the tangent value of the pitch angle of the connecting lines is Y/Z, and the tangent value of the horizontal angle of the connecting lines is X/Z, namely, the tangent value of the pitch angle of the connecting lines is the ratio of the length of the connecting lines in the vertical direction to the length of the connecting lines in the direction vertical to the layer, and the tangent value of the horizontal angle of the connecting lines is the ratio of the length of the connecting lines in the horizontal direction to the length of the connecting lines in the direction vertical to the layer. The tangent value of the pitch angle of each connecting line defines the maximum value and the minimum value of the tangent value corresponding to the pitch angle range, and the tangent value range of the pitch angle range is defined between the maximum value and the minimum value of the tangent value corresponding to the pitch angle range. The tangent value of the horizontal angle of each connecting line defines the maximum value and the minimum value of the tangent value of the horizontal angle range, and the tangent value range of the horizontal angle range is defined between the maximum value and the minimum value of the tangent value of the horizontal angle range.

In some embodiments of the present disclosure, the tangent value of the pitch angle and the tangent value of the horizontal angle corresponding to the connecting line from the human eye position to any vertex is computed through the following modes: acquiring a first direction vector in a screen coordinate system, wherein the first direction vector is a direction vector of a light ray, the light ray is a mapping point from the human eye position to a screen, the mapping point is a point mapped to the screen by a target point, the target point is a vertex of the at least two vertexes in the layer, and the human eye position is at an origin of the screen coordinate system; performing anti-distortion processing on the first direction vector to obtain a second direction vector; performing inverse transformation on the second direction vector to transform the second direction vector into the local coordinate system of the layer to obtain a third direction vector; in the local coordinate system of the layer, taking a sum of the coordinate of the human eye position in the local coordinate system of the layer and a product of the third direction vector and a length of the connecting line as a light ray expression for representing the light ray; and computing the tangent value of the pitch angle and the tangent value of the horizontal angle corresponding to the connecting line from the human eye position to the target point according to an equation relationship between the light ray expression and a coordinate value of the target point in the local coordinate system.

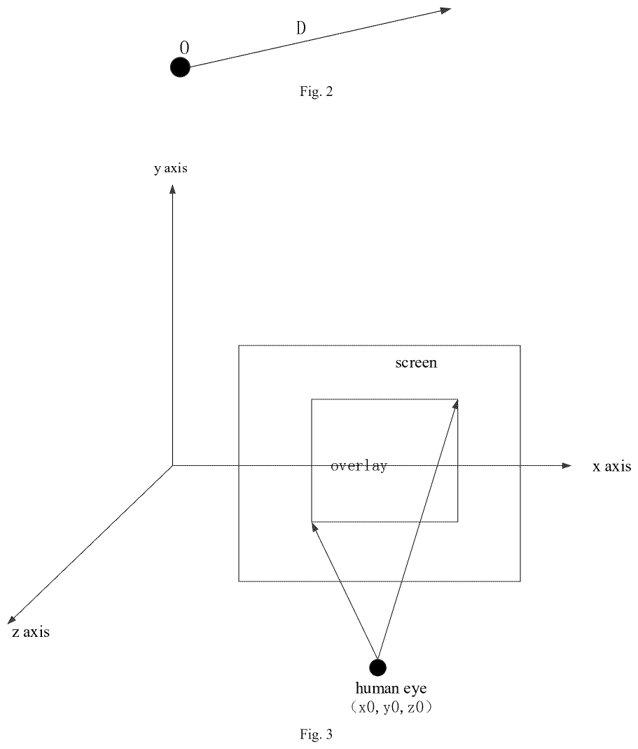

In some embodiments, the target point may be any vertex, which represents the previous vertex of which the tangent value of the pitch angle and the tangent value of the horizontal angle of the connecting line to the human eye position is computed; as shown in FIG. 3, the screen is a curtain of the extended reality world, contents of each layer displayed in the extended reality world are stacked on the screen for display, points on the layer have corresponding light rays in the extended reality world, the light rays are positions of mapping points from the human eye position to the screen, and the target point is the coordinates of the point projected to an overlay (layer) by the light rays; as shown in FIG. 2, the light rays are light rays starting from the human eye position; and as shown in FIG. 2, an end point O represents the coordinates of the human eye position, D represents a unit direction vector, a parametric equation of the light rays is represented as R(t)=O+t*D, in which, t refers to a scalar representing the length of the light rays and is from zero to infinity, and R refers to light rays in a rendering process of the compositor. The position of the screen in the screen coordinate system is known, it is assumed to be a plane which is represented as z=−1 and is vertical to the z axis, the coordinates of the mapping points on the screen can be represented as (x, y, −1) in the screen coordinate system, this value is directly provided by the extended reality device and can be directly obtained; and the human eye position is treated as the origin, the first direction vector of the mapping point from the human eye position to the screen is (x, y, −1), but the points on the screen are not real actually and are obtained through distortion computation actually because the lens has distortion (such as pincushion distortion). Therefore, it is needed to perform anti-distortion computation on x and y coordinate values in the (x, y, −1) to obtain tu and tv; anti-distortion computation needs to be carried out on coordinates of any point on the screen in the screen coordinate system actually; and all points subjected to anti-distortion computation form the screen (the screen is a plane). The second direction vector of the light rays after anti-distortion computation is represented as (tu, tv, −1) in the screen coordinate system, and it is needed to transformed it to be in the local coordinate system of the layer by inverse transformation processing through a model*view matrix, namely the third direction vector of the light rays in the local coordinate system of the layer is represented as D(ax,ay,az)=invert(modelView)*(tu,tv,−1), in which, D (ax, ay, az) refers to the vector representation of the third direction vector in the local coordinate system, invert refers to inverse transformation, at the moment, the human eye position in the local coordinate system of the layer is O (x0, y0, z0), and the connecting lines in the local coordinate system are represented as R(t)=O(x0,y0,z0)+t*D(ax,ay,az); and the coordinate value of the target point in the local coordinate system is solved, namely the coordinates of the point projected by the connecting line from O (x0, y0, z0) in the direction (ax, ay, az) to the plane with the layer are computed. In response to that computation for projection determination is carried out on each vertex, there are n layers, and each layer has 50×50 vertexes, the computation will be computed n!*50*50 times; in order to save drawing, the corresponding pitch angle range and horizontal angle range of the projected connecting lines of a lower left vertex and a right upper vertex (first vertex and the second vertex) of a rectangular graph and the human eye position is computed firstly; in response to that the corresponding pitch angle range and horizontal angle range of the vertexes of other layers are within the range of the layer, the layer may cover the vertexes of other layers, the vertex areas of the layers can be discarded and not drawn in the other layers. The position of the points in the layer is known in the local coordinate system of the layer; the position pointed by the light ray expression is the position of the target point in the local coordinate system, and the two have an equation relationship, for example, by taking the target point as a first vertex (x1, y1, z1) as an example, R(t)=O(x0,y0,z0)+t*D(ax,ay,az)=(x1,y1,z1), t may be represented by different values for different vertexes according to specific conditions, but t will be culled in the process of computing the tangent value, so there is no influence. For any vertex, the direction of the connecting line of the human eye position and the vertex is the same as the direction of D, so the tangent value of the horizontal angle and the tangent value of the pitch angle of the vertex connecting lines are actually ax/az and ay/az in computation.

In some embodiments of the present disclosure, in response to a shape the layer being a rectangle, coordinates of the at least two vertexes of the layer include: a coordinate of a first vertex and a coordinate of a second vertex; the first vertex and the second vertex are two end points on a diagonal line of the rectangle in the local coordinate system; a tangent value range corresponding to the horizontal angle range of the layer is (x1−x0)/(z1−z0) to (x2−x0)/(z2−z0); a tangent value range corresponding to the pitch angle range of the layer is (y1−y0)/(z1−z0) to (y2−y0)/(z2−z0); and in the local coordinate system of the layer, the coordinate of the human eye position is (x0, y0, z0), the coordinate of the first vertex is (x1, y1, z1), and the coordinate of the second vertex is (x2, y2, z2).

In some embodiments, as shown in FIG. 3, the overlay in FIG. 3 is any schematically displayed layer, the layer is in a rectangle shape, and it may be parallel to the screen; coordinates of two end points (a lower left point and an upper right point in FIG. 3, or a lower right point and an upper left point) on an oblique diagonal line of the rectangle include the length and width of the rectangle, the pitch angle range and the horizontal angle range relative to the human eye position can be determined only through the two end points, and thus the computation accuracy is guaranteed while the computation amount is reduced. For the first vertex, splitting is carried out on each axis according to the R(t)=O(x0,y0,z0)+t*D(ax,ay,az)=(x1,y1,z1), and it is assumed that the value of t is f, and actually the value of t does not influence the result. x0+ax*f=x1, y0+ay*f=y1, and z0+az*f=z1 can be obtained, which can be subjected to a simultaneous mode to obtain ax/az=(x1−x0)/(z1−z0), ay/az=(y1−y0)/(z1−z0); it is similar to the second vertex, computation is carried out to obtain ax/az=(x2−x0)/(z2−z0), ay/az=(y2−y0)/(z2−z0) of the second vertex, and the four values are the maximum value and the minimum value of the tangent value range corresponding to the horizontal angle range, and the maximum value and the minimum value of a tangent value range corresponding to the pitch angle range; and the tangent value range can be obtained through the maximum values and the minimum values.

In some embodiments of the present disclosure, a shape of the layer is a curved side of a cylinder, wherein a radian of a circle center corresponding to the curved side is not larger than 180 degrees, and the human eye position is on a side that faces a notch of the curved side; and the at least two vertexes comprise a third vertex, a fourth vertex, a fifth vertex and a sixth vertex, wherein the third vertex and the fourth vertex are vertexes of the curved side on an end surface of the cylinder, and the fifth vertex and the sixth vertex are at two ends of a diagonal line of the largest inscribed rectangle parallel to a height of the cylinder of the curved side.

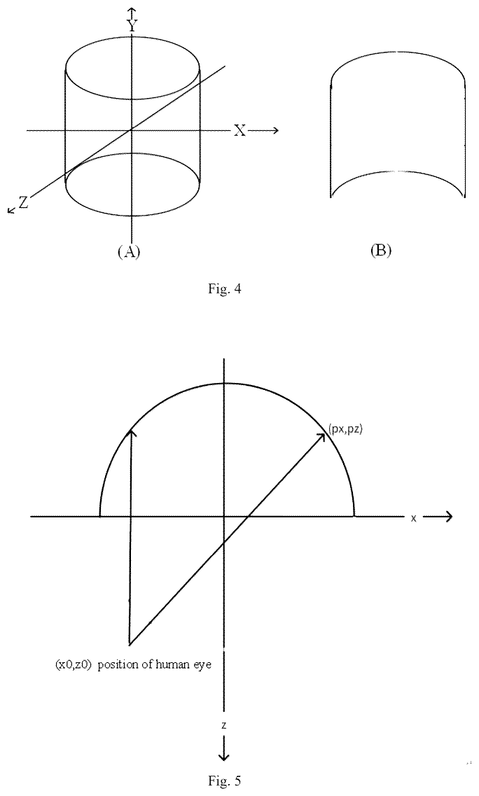

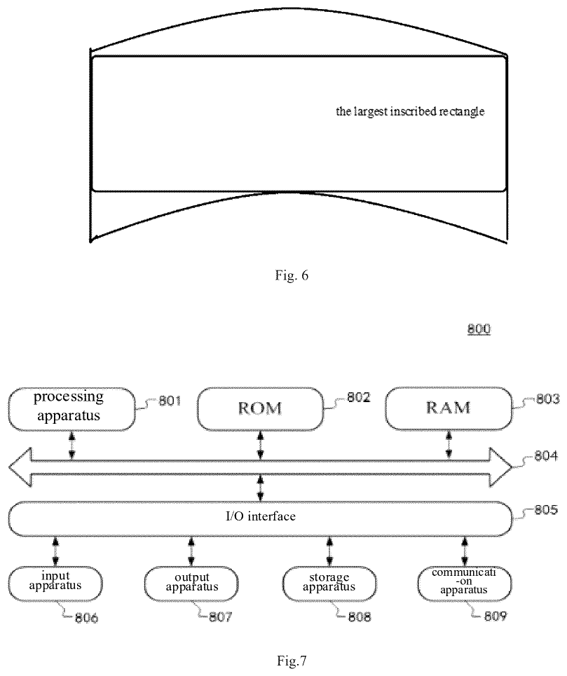

In some embodiments, FIG. 4(A) schematically shows the cylinder, and FIG. 4(B) schematically shows the curved side of the cylinder; the curved side is a part of the side surface of the cylinder and is provided with an upper curved edge, a lower curved edge and two height edges parallel to the height direction; the corresponding circular radian of the curved side is the corresponding circle center radian of the curved edges, and therefore the curved side is half of the side surface of the cylinder at most, and the curved edges are semicircular at the moment. The human eye position is on the side, facing the concave direction, of the curved side, and as shown in FIG. 5, it shows a schematic diagram of the curved side viewed from a negative direction of the y axis (it is assumed that the corresponding circle center radian of the curved side is 180 degrees). The third vertex and the fourth vertex are to be two points in which any curved edge of the curved side intersects with the height; in response to that the corresponding circle center radian of the curved side is 180 degrees, the two points are two points in which a curved plate intersects with the x axis in FIG. 4, and the two points define the horizontal angle range for viewing the curved side from the human eye position. FIG. 6 schematically shows the largest inscribed rectangle of the curved side, and the longitudinal direction in FIG. 6 is the y axis direction; due to the height-position relationship between the curved side and the human eye, the curved side viewed from the human eye position is not a rectangle shape actually, at the moment, the computation can be simplified through the largest inscribed rectangle, the pitch angle range in the vertical direction is represented through the largest inscribed rectangle; and the method is the same as the method for computing the pitch angle range when the layer is in the rectangle shape.

In some embodiments of the present invention, an origin of the local coordinate system of the layer is at a center of the cylinder, an x axis and a y axis in the local coordinate system of the layer are parallel to the end surface of the cylinder, and a z axis is parallel to the height of the cylinder; the determining the pitch angle range and the horizontal angle range of the layer according to the coordinates of the at least two vertexes of the layer and the coordinate of the human eye position in the local coordinate system of the layer includes: determining that a tangent value range corresponding to the horizontal angle range of the layer is (x3−x0)/(z3−z0) to (x4−x0)/(z4−z0); and determining that a tangent value range corresponding to the pitch angle range of the layer is (y5−y0)/(z5−z0) to (y6−y0)/(z6−z0); wherein in the local coordinate system of the layer, the coordinate of the human eye position is (x0, y0, z0), a coordinate of the third vertex is (x3, y3, z3), a coordinate of the fourth vertex is (x4, y4, z4), a coordinate of the fifth vertex is (x5, y5, z5), a coordinate of the sixth vertex is (x6, y6, z6), x3=r×ratio1/sqrt(1+ratio1×ratio1), z3=−x3/ratio1, x4=r×ratio2/sqrt(1+ratio2×ratio2), z4=−x4/ratio2,wherein r refers to a radius of the end surface, ratio1 refers to a tangent value of an included angle between a connecting line of the third vertex and a circle center of the end surface and the x axis in the local coordinate system of the layer; and ratio2 refers to a tangent value of an included angle between a connecting line of the fourth vertex and the circle center of the end surface and the x axis in the local coordinate system of the layer.

In some embodiments, as shown in FIG. 4, it shows the local coordinate system of the layer; the origin is arranged at the geometric center of the cylinder, namely, the origin is at half of the height and on the connecting line of the circle centers of two end surfaces, the radius of the cylinder is r, the y axis is taken as the height for any point (px, py, pz) on the curved edge, and as shown in FIG. 5. The tangent value of an included angle between the connecting line of the point and the circle center and the x axis is represented as ratio=tan α=px/pz, in which, α refers to the included angle between the connecting line of the point and the circle center and the x axis; the point is on the circular edge and meets px*px+pz*pz=r*r, so it can be solved to obtain px=r*ratio/sqrt(1+ratio*ratio), pz=9−px/ratio; in response to that the point is the third vertex (x3, y3, z3), the ratio (namely, the tangent value) of components of the connecting line (light rays) from the human eye position to the third vertex on the x axis and the z axis is (x3−x0)/(z3−z0), it is the maximum value of the tangent value corresponding to the horizontal angle range; and similarly, in response to that the point is the fourth vertex (x4, y4, z4), the ratio (namely, the tangent value) of components of the connecting line (light) from the human eye position to the fourth vertex on the x axis and the z axis is (x4−x0)/(z4−z0), it is the minimum value of the tangent value corresponding to the horizontal angle range; the coordinates of the third vertex and the fourth vertex in the local coordinate system may be obtained from the application with the layer; and the tangent value range corresponding to the horizontal angle range can be obtained by combining the human eye position.

For computation of the pitch angle range, it is needed to compute the range in the y axis direction in FIG. 4; in response to that it is needed to compute the accurate range in the y axis, an accurate projection needs to be computed because y is not a line but an arc, the range cannot be determined through two points. At the moment, it is needed to solve the projection point of each vertex. However, it can be simplified to solve the range of the largest inscribed rectangle, and thus the computation can be greatly reduced. The specific computation mode is the same as the computation mode of the layer in the rectangle shape, two points on the diagonal line are selected, for the fourth vertex, it can be solved according to R(t)=O(x0,y0,z0)+f*D(ax,ay,az)=(x5,y5,z5) to obtain (y5−y0)/(z5−z0); and for the sixth vertex, according to R(t)=O(x0,y0,z0 +f*D(ax,ay,az)=(x6,y6,z6), the tangent value range corresponding to the pitch angle range of the layer is from (y5−y0)/(z5−z0) to (y6−y0)/(z6−z0). It is assumed that the height of the cylinder is 2 and the radius is R, the formula of the light rays in the plane on which the upper left point of the largest inscribed rectangle is (0, 1, −r) in FIG. 6 is R(t)=O(x0,y0,z0)+f*D(ax,ay,az)=(0,1,−r), and it is split onto the z axis and y axis. According to z0+f*az=−r and y0+f*ay=1.0, Y/Z max=ay/az=(1.0−y)/(−r−z) is obtained; and the point at the lower right of the largest inscribed rectangle is computed in a similar way, and Y/Z min=ay/az=(−1.0−y)/(−r−z) is obtained.

According to the sequence from far to near to the human eye position, the number of each layer is sequentially increased from 1; the range of X/Z (the tangent value of the horizontal angle range) and the range of Y/Z (the tangent value of the pitch angle range) of the coverage area in the layers from 1 to n are computed in the above manner; and in response to that the kth layer is to be drawn, and the ratio of the X/Z to the Y/Z of the vertex is within the range of the X/Z and the range of the Y/Z of the coverage area of the m (k<m<=n)th layer, the layer with the vertex can be discarded. According to the present disclosure, the repeated drawing of the layer in the arc-side surface shape can be reduced by 85%, and the repeated drawing of the rectangular layer is completely culled.

The present disclosure further provides an occlusion culling apparatus, which is applied to a compositor of an extended reality device and includes:
a computation unit, configured to determine a coverage range of a layer in the extended reality device, wherein the extended reality device has at least two layers to be drawn; and
a control unit, configured to, in response to a target layer being within the coverage range of a previous layer, skip drawing the target layer in the compositor, in which,
the target layer is a layer except a layer closest to a human eye position in the at least two layers to be drawn, and the previous layer is a layer closer to the human eye position than the target layer.

In some embodiments, the determining a coverage range of a layer in the extended reality device, includes: determining a pitch angle range and a horizontal angle range of the layer relative to the human eye position in a local coordinate system of the layer; and
in response to that a pitch angle range and a horizontal angle range of the target layer are respectively within a pitch angle range and a horizontal angle range of the previous layer, the target layer is within the coverage range of the previous layer.

In some embodiments, the determining a pitch angle range and a horizontal angle range of the layer relative to the human eye position in a local coordinate system of the layer includes:
acquiring coordinates of at least two vertexes of the layer and a coordinate of the human eye position in the local coordinate system of the layer; and
determining the pitch angle range and the horizontal angle range of the layer according to the coordinates of the at least two vertexes of the layer and the coordinate of the human eye position in the local coordinate system of the layer.

In some embodiments, the determining the pitch angle range and the horizontal angle range of the layer according to the coordinates of the at least two vertexes of the layer and the coordinate of the human eye position in the local coordinate system of the layer includes:
computing a tangent value of a pitch angle and a tangent value of a horizontal angle corresponding to a connecting line from the human eye position to each vertex; and
obtaining a tangent value range corresponding to the pitch angle range and a tangent value range corresponding to the horizontal angle range according to the tangent value of the pitch angle and the tangent value of the horizontal angle corresponding to each connecting line, in which,
the tangent value range corresponding to the pitch angle range and the tangent value range corresponding to the horizontal angle range represent the pitch angle range and the horizontal angle range.

In some embodiments, a tangent value of a pitch angle and a tangent value of a horizontal angle corresponding to a connecting line from the human eye position to a vertex are computed through the following modes:
acquiring a first direction vector in a screen coordinate system, wherein the first direction vector is a direction vector of a light ray, the light ray is a mapping point from the human eye position to a screen, the mapping point is a point mapped to the screen by a target point, the target point is a vertex of the at least two vertexes in the layer, and the human eye position is at an origin of the screen coordinate system;
performing anti-distortion processing on the first direction vector to obtain a second direction vector;
performing inverse transformation on the second direction vector to transform the second direction vector into the local coordinate system of the layer to obtain a third direction vector;
in the local coordinate system of the layer, taking a sum of the coordinate of the human eye position in the local coordinate system of the layer and a product of the third direction vector and a length of the connecting line as a light ray expression for representing the light ray; and
computing the tangent value of the pitch angle and the tangent value of the horizontal angle corresponding to the connecting line from the human eye position to the target point according to an equation relationship between the light ray expression and a coordinate value of the target point in the local coordinate system.

In some embodiments, in response to a shape the layer being a rectangle, coordinates of the at least two vertexes of the layer include: a coordinate of a first vertex and a coordinate of a second vertex; wherein the first vertex and the second vertex are two end points on a diagonal line of the rectangle in the local coordinate system;
a tangent value range corresponding to the horizontal angle range of the layer is (x1−x0)/(z1−z0) to (x2−x0)/(z2−z0);
a tangent value range corresponding to the pitch angle range of the layer is (y1−y0)/(z1−z0) to (y2−y0)/(z2−z0) and
in the local coordinate system of the layer, the coordinate of the human eye position is (x0, y0, z0), the coordinate of the first vertex is (x1, y1, z1), and the coordinate of the second vertex is (x2, y2, z2).

In some embodiments, a shape of the layer is a curved side of a cylinder, wherein a radian of a circle center corresponding to the curved side is not larger than 180 degrees, and the human eye position is on a side that faces a notch of the curved side; and
the at least two vertexes comprise a third vertex, a fourth vertex, a fifth vertex and a sixth vertex, wherein the third vertex and the fourth vertex are vertexes of the curved side on an end surface of the cylinder, and the fifth vertex and the sixth vertex are at two ends of a diagonal line of the largest inscribed rectangle parallel to a height of the cylinder of the curved side.

In some embodiments, an origin of the local coordinate system of the layer is at a center of the cylinder, an x axis and a y axis in the local coordinate system of the layer are parallel to the end surface of the cylinder, and a z axis is parallel to the height of the cylinder;
the determining the pitch angle range and the horizontal angle range of the layer according to the coordinates of the at least two vertexes of the layer and the coordinate of the human eye position in the local coordinate system of the layer includes:
determining that a tangent value range corresponding to the horizontal angle range of the layer is (x3−x0)/(z3−z0) to (x4−x0)/(z4−z0); and
determining that a tangent value range corresponding to the pitch angle range of the layer is (y5−y0)/(z5−z0) to (y6−y0)/(z6−z0);
in the local coordinate system of the layer, the coordinate of the human eye position is (x0, y0, z0), a coordinate of the third vertex is (x3, y3, z3), a coordinate of the fourth vertex is (x4, y4, z4), a coordinate of the fifth vertex is (x5, y5, z5), a coordinate of the sixth vertex is (x6, y6, z6), x3=r×ratio1/sqrt(1+ratio1×ratio1), z3=−x3/ratio1, x4=r×ratio2/sqrt(1+ratio2×ratio2), z4=−x4/ratio2, wherein r refers to a radius of the end surface, ratio1 refers to a tangent value of an included angle between a connecting line of the third vertex and a circle center of the end surface and the x axis in the local coordinate system of the layer; and ratio2 refers to a tangent value of an included angle between a connecting line of the fourth vertex and the circle center of the end surface and the x axis in the local coordinate system of the layer.

For the embodiment of the apparatus, because it basically corresponds to the method embodiment, relevant parts may be referred to part of the description in the method embodiment. The apparatus embodiments described above are only schematic, and the modules described therein as descriptions of isolation modules may or may not be separated. Some or all of the modules can be selected according to actual needs to realize the purpose of the solution of the present embodiment. Those of ordinary skill in the art may understand and implement it without creative effort.

As described above, the method and apparatus according to the present disclosure are illustrated based on the embodiments and the examples. In addition, the present disclosure further provides a terminal and a storage medium which are described below.

With reference to FIG. 7, it is a structure schematic diagram of an electronic device (such as a terminal device or a server) 800 suitable for implementing the embodiment of the present disclosure. The terminal device in the embodiment of the present disclosure can include but is not limited to mobile terminals such as a mobile phone, a notebook computer, a digital broadcast receiver, a PDA (personal digital assistant), a PAD (tablet personal computer), a PMP (portable multimedia player), and a vehicle-mounted terminal (such as a vehicle-mounted navigation terminal), and immobile terminals such as a digital TV, a desktop computer. The electronic device shown in FIG. 5 is only an example, and does not bring any limitation to the functions and the use range of the embodiment of the present disclosure.

As shown in FIG. 7, the electronic device 800 can include a processing apparatus (such as a central processor, and a graphic processor) 801, which can perform various appropriate actions and processing according to a program stored in a read-only memory (ROM) 802 or a program loaded from a storage apparatus 808 to a Random Access Memory (RAM) 803. In the RAM 803, various programs and data required for operation of the electronic device 800 are also stored. The processing apparatus 801, ROM 802 and RAM 803 are connected to one another through a bus 804. An input/output (I/O) interface 805 is also connected to the bus 804.

Generally, the following apparatuses can be connected to the I/O interface 805: an input apparatus 806 including, for example, a touch screen, a touch pad, a keyboard, a mouse, a camera, a microphone, an accelerometer, and a gyroscope, an output apparatus 807 including, for example, a Liquid Crystal Display (LCD), a loudspeaker, and a vibrator, a storage apparatus 808 including, for example, a magnetic tape, and a hard disk, and a communication apparatus 809. The communication apparatus 809 can allow the electronic device 800 to perform wireless or wired communication with other electronic devices to exchange data. Although the electronic device 800 with various apparatuses is shown in the drawings, it is to be understood that it is not needed to implement or provided with all the shown apparatuses. It can be alternatively implemented or provided with more or less apparatuses.

Particularly, according to the embodiment of the present disclosure, the process described with reference to the flowchart can be implemented as a computer software program. For example, an embodiment of the present disclosure includes a computer program product which includes a computer program carried on a computer-readable medium, and the computer program contains program codes for executing the method in the flowchart. In such embodiment, the computer program can be downloaded and installed from a network through the communication apparatus 809, or installed from the storage apparatus 808, or installed from the ROM 802. In response to that the computer program is executed by the processing apparatus 801, functions defined in the method according to the embodiment of the present disclosure can be realized.

It is to be noted that the computer-readable medium described above of the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or instrument, or any combination thereof. More specific examples of the computer-readable storage media may be include, but not limited to, an electrical connector, a portable computer disk, a hard disk, a Random Access Memory (RAM), a Read Only Memory (ROM), an erasable programmable read only memory (EPROM or flash memory), an optical fiber, a portable compact disk read only memory (CD-ROM), an optical storage device, a magnetic storage device, or any suitable combination thereof having one or more wires. In the present disclosure, the computer-readable storage medium may be any tangible medium containing or storing a program that may be used by or in combination with an instruction execution system, apparatus or instrument. In the present disclosure, the computer-readable signal medium may include a data signal that propagates in a baseband or as part of a carrier, in which, the computer-readable program code is carried. Such propagated data signal may take a variety of forms, including, but not limited to, an electromagnetic signal, an optical signal, or any suitable combination thereof. The computer-readable signal medium may also be any computer-readable medium other than the computer-readable storage medium that may transmit, propagate, or transmit a program for use by or in combination with the instruction execution system, apparatus or instrument. The program code contained on the computer-readable medium may be transmitted with any suitable medium, including, but not limited to, an electrical wire, an optical cable, an RF (radio frequency), or any suitable combination thereof.

In some embodiments, a client and the server may communicate using any currently known or future developed network protocol, such as HTTP (HyperText Transfer Protocol), and may interconnect with digital data communications (e.g., communications networks) of any form or medium. Examples of the communications networks include local area networks (“LANs”), wide area networks (“WANs”), Internet networks (e.g., Internet) and end-to-end networks (e.g., ad hoc end-to-end networks), and any currently known or future developed networks.

The computer-readable medium may be contained in the electronic device described above, or may be present alone, without being assembled into the electronic device.

The computer-readable medium carries one or more programs, and in response to that the one or more programs are executed by the terminal device, the terminal device is configured to execute the method according to the present disclosure.

The computer program code for executing the operations of the present disclosure may be written in one or more programming languages or a combination thereof, including, but not limited to, object-oriented programming languages, such as Java, Smalltalk, C++, and conventional procedural programming languages, such as “C” or similar programming languages. The program code can be executed entirely on a user computer, partially on the user computer, as a separate software package, partially on the user computer and partially on a remote computer, or entirely on the remote computer or server. In response to involve the remote computer, the remote computer may be connected to the user computer through any type of network, including the local area network (LAN) or the wide area network (WAN), or, may be connected to an external computer (e.g., via Internet service provider using Internet).

The flowchart and block diagram in the accompanying drawings illustrate the architecture, functions and operations that may be implemented by systems, methods and computer program products according to the various embodiments of the present disclosure. In this regard, each block in the flowchart or block diagram may represent a module, program segment, or part of code, and the module, program segment, or part of code contains one or more executable instructions for implementing a prescribed logical function. It is also to be noted that in some embodiments as an alternative, the functions marked in the blocks may also occur in a different order than in the accompanying drawings. For example, two blocks represented in succession may actually be executed substantially in parallel, and sometimes in an opposite order, depending on the function involved. It is also to be noted that each block in the block diagram and/or flowchart, and the combination of blocks in the block diagram and/or flowchart, may be implemented in a dedicated hardware-based system that executes the prescribed function or operation, or may be implemented in a combination of dedicated hardware and computer instructions.

The units described in the embodiments of the present disclosure can be implemented either in software, or in hardware. The names of the units do not form a limitation to the unit itself in some cases.

The functions described above can be performed at least in part by one or more hardware logic components. For example, non-limiting, exemplary types of hardware logic components that can be used include: Field Programmable Gate Arrays (FPGAs), Application Specific Integrated Circuits (ASICs), Application Specific Standard Products (ASSPs), system-on-chips (SOCs), Complex Programmable Logic Devices (CPLDs), etc.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, the electronic, magnetic, optical, electromagnetic, infrared, or semiconductor system, apparatus, or device, or any suitable combination of the foregoing. A more specific example of the machine-readable storage medium may include an electrical connector based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, an occlusion culling method is provided, which is used to a compositor of an extended reality device, and the method includes:
determining a coverage range of a layer in the extended reality device, wherein the extended reality device has at least two layers to be drawn; and
in response to a target layer being within a coverage range of a previous layer, not drawing the target layer in the compositor,
the target layer is a layer except a layer closest to a human eye position in the at least two layers to be drawn, and the previous layer is a layer closer to the human eye position than the target layer.

According to one or more embodiments of the present disclosure, an occlusion culling method is provided, the determining a coverage range of a layer in the extended reality device includes: determining a pitch angle range and a horizontal angle range of the layer relative to the human eye position in a local coordinate system of the layer; and
in response to that a pitch angle range and a horizontal angle range of the target layer are respectively within a pitch angle range and a horizontal angle range of the previous layer, the target layer is within the coverage range of the previous layer.

According to one or more embodiments of the present disclosure, an occlusion culling method is provided, the determining a pitch angle range and a horizontal angle range of the layer relative to the human eye position in a local coordinate system of the layer includes:
acquiring coordinates of at least two vertexes of the layer and a coordinate of the human eye position in the local coordinate system of the layer; and
determining the pitch angle range and the horizontal angle range of the layer according to the coordinates of the at least two vertexes of the layer and the coordinate of the human eye position in the local coordinate system of the layer.

According to one or more embodiments of the present disclosure, an occlusion culling method is provided, the determining the pitch angle range and the horizontal angle range of the layer according to the coordinates of the at least two vertexes of the layer and the coordinate of the human eye position in the local coordinate system of the layer includes:
computing a tangent value of a pitch angle and a tangent value of a horizontal angle corresponding to a connecting line from the human eye position to each vertex; and
obtaining a tangent value range corresponding to the pitch angle range and a tangent value range corresponding to the horizontal angle range according to the tangent value of the pitch angle and the tangent value of the horizontal angle corresponding to each connecting line,
the tangent value range corresponding to the pitch angle range and the tangent value range corresponding to the horizontal angle range represent the pitch angle range and the horizontal angle range.

According to one or more embodiments of the present disclosure, an occlusion culling method is provided,

According to one or more embodiments of the present disclosure, an occlusion culling method is provided, tangent value of a pitch angle and a tangent value of a horizontal angle corresponding to a connecting line from the human eye position to a vertex are computed through the following modes:
acquiring a first direction vector in a screen coordinate system, wherein the first direction vector is a direction vector of a light ray, the light ray is a mapping point from the human eye position to a screen, the mapping point is a point mapped to the screen by a target point, the target point is a vertex of the at least two vertexes in the layer, and the human eye position is at an origin of the screen coordinate system;
performing anti-distortion processing on the first direction vector to obtain a second direction vector;
performing inverse transformation on the second direction vector to transform the second direction vector into the local coordinate system of the layer to obtain a third direction vector;
in the local coordinate system of the layer, taking a sum of the coordinate of the human eye position in the local coordinate system of the layer and a product of the third direction vector and a length of the connecting line as a light ray expression for representing the light ray; and
computing the tangent value of the pitch angle and the tangent value of the horizontal angle corresponding to the connecting line from the human eye position to the target point according to an equation relationship between the light ray expression and a coordinate value of the target point in the local coordinate system.

According to one or more embodiments of the present disclosure, an occlusion culling method is provided, in response to a shape the layer being a rectangle, coordinates of the at least two vertexes of the layer comprise: a coordinate of a first vertex and a coordinate of a second vertex; wherein the first vertex and the second vertex are two end points on a diagonal line of the rectangle in the local coordinate system;
a tangent value range corresponding to the horizontal angle range of the layer is (x1−x0)/(z1−z0) to (x2−x0)/(z2−z0);
a tangent value range corresponding to the pitch angle range of the layer is (y1−y0)/(z1−z0) to (y2−y0)/(z2−z0); and
wherein in the local coordinate system of the layer, the coordinate of the human eye position is (x0, y0, z0), the coordinate of the first vertex is (x1, y1, z1), and the coordinate of the second vertex is (x2, y2, z2).

According to one or more embodiments of the present disclosure, an occlusion culling method is provided, a shape of the layer is a curved side of a cylinder, wherein a radian of a circle center corresponding to the curved side is not larger than 180 degrees, and the human eye position is on a side that faces a notch of the curved side; and
the at least two vertexes comprise a third vertex, a fourth vertex, a fifth vertex and a sixth vertex, wherein the third vertex and the fourth vertex are vertexes of the curved side on an end surface of the cylinder, and the fifth vertex and the sixth vertex are at two ends of a diagonal line of the largest inscribed rectangle parallel to a height of the cylinder of the curved side.

According to one or more embodiments of the present disclosure, an occlusion culling method is provided, an origin of the local coordinate system of the layer is at a center of the cylinder, an x axis and a y axis in the local coordinate system of the layer are parallel to the end surface of the cylinder, and a z axis is parallel to the height of the cylinder;
the determining the pitch angle range and the horizontal angle range of the layer according to the coordinates of the at least two vertexes of the layer and the coordinate of the human eye position in the local coordinate system of the layer comprises:
determining that a tangent value range corresponding to the horizontal angle range of the layer is (x3−x0)/(z3−z0) to (x4−x0)/(z4−z0); and
determining that a tangent value range corresponding to the pitch angle range of the layer is (y5−y0)/(z5−z0) to (y6−y0)/(z6−z0);
wherein in the local coordinate system of the layer, the coordinate of the human eye position is (x0, y0, z0), a coordinate of the third vertex is (x3, y3, z3), a coordinate of the fourth vertex is (x4, y4, z4), a coordinate of the fifth vertex is (x5, y5, z5), a coordinate of the sixth vertex is (x6, y6, z6), x3=r×ratio1/sqrt(1+ratio1×ratio1), z3=−x3/ratio1, x4=r×ratio2/sqrt(1+ratio2×ratio2), z4=−x4/ratio2, wherein r refers to a radius of the end surface, ratio1 refers to a tangent value of an included angle between a connecting line of the third vertex and a circle center of the end surface and the x axis in the local coordinate system of the layer; and ratio2 refers to a tangent value of an included angle between a connecting line of the fourth vertex and the circle center of the end surface and the x axis in the local coordinate system of the layer.

According to one or more embodiments of the present disclosure, an occlusion culling apparatus is provided, which is used to a compositor of an extended reality device, and the apparatus includes:
a computation unit, configured to determine a coverage range of a layer in the extended reality device, wherein the extended reality device has at least two layers to be drawn;
a control unit, configured to, in response to a target layer being within the coverage range of a previous layer, skip drawing the target layer in the compositor;
the target layer is a layer except a layer closest to a human eye position in the at least two layers to be drawn, and the previous layer is a layer closer to the human eye position than the target layer.

According to one or more embodiments of the present disclosure, an electronic device is provided and includes: at least one memory and at least one processor;
the at least one memory is configured to store program codes; and the at least one processor is configured to call the program codes stored in the at least one memory to execute the method according any method described as above.

According to one or more embodiments of the present disclosure, a computer-readable storage medium is provided which is is used to store program codes, the program codes are executed in a computer to cause the computer to execute the method according to any method described as above.

The above descriptions are only a better embodiment of the present disclosure and a description of the technical principles used. Those skilled in the art should understand that the scope of disclosure involved in the present disclosure is not limited to the technical solutions formed by the specific combination of the above-mentioned technical features, but shall also cover other technical solutions formed by any combination of the above-mentioned technical features or their equivalent features without departing from the above-mentioned disclosure concept. For example, a technical solution formed by replacing the above-mentioned features with (but not limited to) technical features with similar functions disclosed in the present disclosure.

In addition, although operations are depicted in a specific order, it is not to be understood as requiring these operations to be performed in the specific order in which they are shown or in a sequential order. In some context, multitasking and parallel processing may be beneficial. Similarly, although a number of specific implementation details are included in the above discussion, these should not be understood as limiting the scope of the present disclosure. Some features described in the context of individual embodiments may also be implemented in combination in a single embodiment. Conversely, the various features described in the context of a single embodiment may also be implemented in a plurality of embodiments individually or in any suitable combination of sub-embodiments.

Although the subject matter has been described in language specific to the structural features and/or logical actions of the method, it is to be understood that the subject matter defined in the attached claims is not necessarily limited to the specific features or actions described above. Conversely, the specific features and actions described above are only exemplary forms of realizing the claims.

1. An occlusion culling method, wherein the method is used to a compositor of an extended reality device, the method comprises:
determining a coverage range of a layer in the extended reality device, wherein the extended reality device has at least two layers to be drawn; and
in response to a target layer being within a coverage range of a previous layer, not drawing the target layer in the compositor,
wherein the target layer is a layer except a layer closest to a human eye position in the at least two layers to be drawn, and the previous layer is a layer closer to the human eye position than the target layer.

2. The method according to claim 1, wherein the determining a coverage range of a layer in the extended reality device comprises: determining a pitch angle range and a horizontal angle range of the layer relative to the human eye position in a local coordinate system of the layer; and
in response to that a pitch angle range and a horizontal angle range of the target layer are respectively within a pitch angle range and a horizontal angle range of the previous layer, the target layer is within the coverage range of the previous layer.

3. The method according to claim 2, wherein the determining a pitch angle range and a horizontal angle range of the layer relative to the human eye position in a local coordinate system of the layer comprises:
acquiring coordinates of at least two vertexes of the layer and a coordinate of the human eye position in the local coordinate system of the layer; and
determining the pitch angle range and the horizontal angle range of the layer according to the coordinates of the at least two vertexes of the layer and the coordinate of the human eye position in the local coordinate system of the layer.

4. The method according to claim 3, wherein the determining the pitch angle range and the horizontal angle range of the layer according to the coordinates of the at least two vertexes of the layer and the coordinate of the human eye position in the local coordinate system of the layer comprises:
computing a tangent value of a pitch angle and a tangent value of a horizontal angle corresponding to a connecting line from the human eye position to each vertex; and
obtaining a tangent value range corresponding to the pitch angle range and a tangent value range corresponding to the horizontal angle range according to the tangent value of the pitch angle and the tangent value of the horizontal angle corresponding to each connecting line,
wherein the tangent value range corresponding to the pitch angle range and the tangent value range corresponding to the horizontal angle range represent the pitch angle range and the horizontal angle range.

5. The method according to claim 4, wherein a tangent value of a pitch angle and a tangent value of a horizontal angle corresponding to a connecting line from the human eye position to a vertex are computed through the following modes:
acquiring a first direction vector in a screen coordinate system, wherein the first direction vector is a direction vector of a light ray, the light ray is a mapping point from the human eye position to a screen, the mapping point is a point mapped to the screen by a target point, the target point is a vertex of the at least two vertexes in the layer, and the human eye position is at an origin of the screen coordinate system;
performing anti-distortion processing on the first direction vector to obtain a second direction vector;
performing inverse transformation on the second direction vector to transform the second direction vector into the local coordinate system of the layer to obtain a third direction vector;
in the local coordinate system of the layer, taking a sum of the coordinate of the human eye position in the local coordinate system of the layer and a product of the third direction vector and a length of the connecting line as a light ray expression for representing the light ray; and
computing the tangent value of the pitch angle and the tangent value of the horizontal angle corresponding to the connecting line from the human eye position to the target point according to an equation relationship between the light ray expression and a coordinate value of the target point in the local coordinate system.

6. The method according to claim 3, wherein
in response to a shape the layer being a rectangle, coordinates of the at least two vertexes of the layer comprise: a coordinate of a first vertex and a coordinate of a second vertex; wherein the first vertex and the second vertex are two end points on a diagonal line of the rectangle in the local coordinate system;
a tangent value range corresponding to the horizontal angle range of the layer is (x1−x0)/(z1−z0) to (x2−x0)/(z2−z0);
a tangent value range corresponding to the pitch angle range of the layer is (y1−y0)/(z1−z0) to (y2−y0)/(z2−z0); and
wherein in the local coordinate system of the layer, the coordinate of the human eye position is (x0, y0, z0), the coordinate of the first vertex is (x1, y1, z1), and the coordinate of the second vertex is (x2, y2, z2).

7. The method according to claim 3, wherein
a shape of the layer is a curved side of a cylinder, wherein a radian of a circle center corresponding to the curved side is not larger than 180 degrees, and the human eye position is on a side that faces a notch of the curved side; and
the at least two vertexes comprise a third vertex, a fourth vertex, a fifth vertex and a sixth vertex, wherein the third vertex and the fourth vertex are vertexes of the curved side on an end surface of the cylinder, and the fifth vertex and the sixth vertex are at two ends of a diagonal line of the largest inscribed rectangle parallel to a height of the cylinder of the curved side.

8. The method according to claim 7, wherein
an origin of the local coordinate system of the layer is at a center of the cylinder, an x axis and a y axis in the local coordinate system of the layer are parallel to the end surface of the cylinder, and a z axis is parallel to the height of the cylinder;
the determining the pitch angle range and the horizontal angle range of the layer according to the coordinates of the at least two vertexes of the layer and the coordinate of the human eye position in the local coordinate system of the layer comprises:
determining that a tangent value range corresponding to the horizontal angle range of the layer is (x3−x0)/(z3−z0) to (x4−x0)/(z4−z0); and
determining that a tangent value range corresponding to the pitch angle range of the layer is (y5−y0)/(z5−z0) to (y6−y0)/(z6−z0);
wherein in the local coordinate system of the layer, the coordinate of the human eye position is (x0, y0, z0), a coordinate of the third vertex is (x3, y3, z3), a coordinate of the fourth vertex is (x4, y4, z4), a coordinate of the fifth vertex is (x5, y5, z5), a coordinate of the sixth vertex is (x6, y6, z6), x3=r×ratio1/sqrt(1+ratio1×ratio1), z3=−x3/ratio1, x4=r×ratio2/sqrt(1+ratio2×ratio2), z4=−x4/ratio2, wherein r refers to a radius of the end surface, ratio1 refers to a tangent value of an included angle between a connecting line of the third vertex and a circle center of the end surface and the x axis in the local coordinate system of the layer; and ratio2 refers to a tangent value of an included angle between a connecting line of the fourth vertex and the circle center of the end surface and the x axis in the local coordinate system of the layer.

9. An electronic device, comprising:
at least one memory and at least one processor;
wherein the at least one memory is configured to store program codes; and the at least one processor is configured to call the program codes stored in the at least one memory to execute an occlusion culling method, wherein the method is used to a compositor of an extended reality device, and the method comprises:
determining a coverage range of a layer in the extended reality device, wherein the extended reality device has at least two layers to be drawn; and
in response to a target layer being within a coverage range of a previous layer, not drawing the target layer in the compositor,
wherein the target layer is a layer except a layer closest to a human eye position in the at least two layers to be drawn, and the previous layer is a layer closer to the human eye position than the target layer.

10. The electronic device according to claim 9, wherein the determining a coverage range of a layer in the extended reality device comprises: determining a pitch angle range and a horizontal angle range of the layer relative to the human eye position in a local coordinate system of the layer; and
in response to that a pitch angle range and a horizontal angle range of the target layer are respectively within a pitch angle range and a horizontal angle range of the previous layer, the target layer is within the coverage range of the previous layer.

11. The electronic device according to claim 10, wherein the determining a pitch angle range and a horizontal angle range of the layer relative to the human eye position in a local coordinate system of the layer comprises:
acquiring coordinates of at least two vertexes of the layer and a coordinate of the human eye position in the local coordinate system of the layer; and
determining the pitch angle range and the horizontal angle range of the layer according to the coordinates of the at least two vertexes of the layer and the coordinate of the human eye position in the local coordinate system of the layer.

12. The electronic device according to claim 11, wherein the determining the pitch angle range and the horizontal angle range of the layer according to the coordinates of the at least two vertexes of the layer and the coordinate of the human eye position in the local coordinate system of the layer comprises:
computing a tangent value of a pitch angle and a tangent value of a horizontal angle corresponding to a connecting line from the human eye position to each vertex; and
obtaining a tangent value range corresponding to the pitch angle range and a tangent value range corresponding to the horizontal angle range according to the tangent value of the pitch angle and the tangent value of the horizontal angle corresponding to each connecting line,
wherein the tangent value range corresponding to the pitch angle range and the tangent value range corresponding to the horizontal angle range represent the pitch angle range and the horizontal angle range.

13. The electronic device according to claim 12, wherein a tangent value of a pitch angle and a tangent value of a horizontal angle corresponding to a connecting line from the human eye position to a vertex are computed through the following modes:
acquiring a first direction vector in a screen coordinate system, wherein the first direction vector is a direction vector of a light ray, the light ray is a mapping point from the human eye position to a screen, the mapping point is a point mapped to the screen by a target point, the target point is a vertex of the at least two vertexes in the layer, and the human eye position is at an origin of the screen coordinate system;
performing anti-distortion processing on the first direction vector to obtain a second direction vector;
performing inverse transformation on the second direction vector to transform the second direction vector into the local coordinate system of the layer to obtain a third direction vector;
in the local coordinate system of the layer, taking a sum of the coordinate of the human eye position in the local coordinate system of the layer and a product of the third direction vector and a length of the connecting line as a light ray expression for representing the light ray; and
computing the tangent value of the pitch angle and the tangent value of the horizontal angle corresponding to the connecting line from the human eye position to the target point according to an equation relationship between the light ray expression and a coordinate value of the target point in the local coordinate system.

14. The electronic device according to claim 11, wherein
in response to a shape the layer being a rectangle, coordinates of the at least two vertexes of the layer comprise: a coordinate of a first vertex and a coordinate of a second vertex; wherein the first vertex and the second vertex are two end points on a diagonal line of the rectangle in the local coordinate system;
a tangent value range corresponding to the horizontal angle range of the layer is (x1−x0)/(z1−z0) to (x2−x0)/(z2−z0);
a tangent value range corresponding to the pitch angle range of the layer is (y1−y0)/(z1−z0) to (y2−y0)/(z2−z0); and
wherein in the local coordinate system of the layer, the coordinate of the human eye position is (x0, y0, z0), the coordinate of the first vertex is (x1, y1, z1), and the coordinate of the second vertex is (x2, y2, z2).

15. The electronic device according to claim 11, wherein
a shape of the layer is a curved side of a cylinder, wherein a radian of a circle center corresponding to the curved side is not larger than 180 degrees, and the human eye position is on a side that faces a notch of the curved side; and
the at least two vertexes comprise a third vertex, a fourth vertex, a fifth vertex and a sixth vertex, wherein the third vertex and the fourth vertex are vertexes of the curved side on an end surface of the cylinder, and the fifth vertex and the sixth vertex are at two ends of a diagonal line of the largest inscribed rectangle parallel to a height of the cylinder of the curved side.

16. The electronic device according to claim 15, wherein
an origin of the local coordinate system of the layer is at a center of the cylinder, an x axis and a y axis in the local coordinate system of the layer are parallel to the end surface of the cylinder, and a z axis is parallel to the height of the cylinder;
the determining the pitch angle range and the horizontal angle range of the layer according to the coordinates of the at least two vertexes of the layer and the coordinate of the human eye position in the local coordinate system of the layer comprises:
determining that a tangent value range corresponding to the horizontal angle range of the layer is (x3−x0)/(z3−z0) to (x4−x0)/(z4−z0); and
determining that a tangent value range corresponding to the pitch angle range of the layer is (y5−y0)/(z5−z0) to (y6−y0)/(z6−z0);
wherein in the local coordinate system of the layer, the coordinate of the human eye position is (x0, y0, z0), a coordinate of the third vertex is (x3, y3, z3), a coordinate of the fourth vertex is (x4, y4, z4), a coordinate of the fifth vertex is (x5, y5, z5), a coordinate of the sixth vertex is (x6, y6, z6), x3=r×ratio1/sqrt(1+ratio1×ratio1), z3=−x3/ratio1, x4=r×ratio2/sqrt(1+ratio2×ratio2), z4=−x4/ratio2, wherein r refers to a radius of the end surface, ratio1refers to a tangent value of an included angle between a connecting line of the third vertex and a circle center of the end surface and the x axis in the local coordinate system of the layer; and ratio2 refers to a tangent value of an included angle between a connecting line of the fourth vertex and the circle center of the end surface and the x axis in the local coordinate system of the layer.

17. A non-transitory computer-readable storage medium, wherein the computer-readable storage medium is used to store program codes, the program codes are executed in a computer to cause the computer to execute an occlusion culling method, wherein the method is used to a compositor of an extended reality device, and the method comprises:
determining a coverage range of a layer in the extended reality device, wherein the extended reality device has at least two layers to be drawn; and
in response to a target layer being within a coverage range of a previous layer, not drawing the target layer in the compositor,
wherein the target layer is a layer except a layer closest to a human eye position in the at least two layers to be drawn, and the previous layer is a layer closer to the human eye position than the target layer.
